(19) United States
(12) Patent Application Publication
(10) Pub. No.: US 2019/0143617 A1
(43) Pub. Date: May 16, 2019

(54) Method for Manufacturing a Volume Element Inflatable With a Gas, In Particular a Water Sports Equipment

(71) Applicant: Stefan KLARE, München (DE)

(72) Inventor: Stefan KLARE, München (DE)

(21) Appl. No.: 16/300,462

(22) PCT Filed: May 10, 2017
(86) PCT No.: PCT/EP2017/061170

§ 371 Date: Nov. 9, 2018

(30) Foreign Application Priority Data
May 10, 2016 (DE) 10 2016 108 635.5

(51) Int. Cl. B29D 22/02; B63B 7/08; B63B 35/79

(52) U.S. Cl. CPC B29D 22/02; B29L 2031/5272; B63B 35/7913; B63B 7/08

(57) ABSTRACT

The invention relates to a method for manufacturing volume element (10) which is inflatable with a gas, the method comprising the steps of:
providing at least one first tube element (12) which comprises at least one first tube (1, 4) which is inflatable with the gas and is formed by at least two layers which are arranged one above the other, are formed from a per se limp material, and are connected with each other along at least one first seam (16d, 36); and
providing at least one second tube element (14, 15) which comprises at least one second tube (5, 8) which is inflatable with the gas and is formed by at least two layers which are arranged one above the other, are formed from a per se limp material, and are connected with each other along at least one second seam (18d, 38), wherein the tube elements (12, 14) are provided in such a way that the seams (16d, 18d, 36, 38) are arranged on mutually facing sides of the tube elements (12, 14) and have, at least in respective length portions (40), curvatures that are different from each other.

The invention relates to a method for manufacturing a volume element, which is inflatable with a gas, in particular a water sports equipment.

Such a volume element in the form of a water sports equipment can be taken as known from the US 2009/0049757 A1. There, the volume element is referred to as sandwich beam, which is inflatable with a gas. For this purpose, the sandwich beam has a core with at least one inner chamber, which is inflatable with the gas. Therein, the inner chamber is bordered by an at least substantially limp material.

Moreover a vacuum pocket is provided as at least one outer chamber, which is bordered by an per se at least substantially limp material, which is referred to as bag material. Therein, the outer chamber is fluidically separate from the inner chamber and surrounds the inner chamber on the outer circumference at least in portions. A vacuum connection is provided, via which the outer chamber can be evacuated. In the outer chamber a compression element with two foil webs, which are disposed in mutual overlap, is provided. By evacuating the outer chamber it is downsized such that the foil webs are pressed away from each other. Thereby, the foil webs are clamped together by friction. For realizing particularly strong clamping together of the foil webs, the friction coefficient between them can be increased for example by using particles.

Also from the FR 2 516 887 a volume element configured as water sports equipment can be taken as known.

It has turned out that the manufacture of advantageous, though complex geometries or structures of volume elements is not possible or only with great effort. Such complex geometries, in particular variable thickness distributions, up to date are not realizable or not realizable cost-efficiently and thus in a manner suitable for large series. Such complex geometries, however, are desired and advantageous to realize advantageous properties of the volume element for its use as or for a water sports equipment. Commonly, there is the problem that the volume element in its state inflatable with the gas has excessive folds. Such folds can impair the optical impression of the volume element, but also its properties, in particular when using the volume element as water sports equipment. Such manufacture of the volume element that the volume element in its inflated state has no or only slight folds whilst at the same time realizing a particularly advantageous, though complex geometry or structure of the volume element, is hitherto not possible or only with great effort and thus in a time-consuming and cost-intensive way.

It is therefore the object of the present invention to provide a method for manufacturing a volume element, which is inflatable with a gas, so that a particularly advantageous structure of the volume element can be realized, wherein the volume element in its gas-inflated state has no excessive folds and can be manufactured in a particularly time-efficient and cost-efficient way.

This object is solved by a method with the features of patent claim 1. Advantageous embodiments with expedient further developments of the invention are indicated in the remaining claims.

According to the invention the method for manufacturing a volume element which is inflatable with a gas, in particular with air, is characterized by a first step in which at least one first tube element is provided. The first tube element comprises at least one first tube which is inflatable with the gas and is formed by at least two layers or plies arranged one on top of the other, each formed from a per se limp material and connected with each other along at least one seam. Further, the first tube can comprise at least one free end.

The method according to the invention further comprises a second step in which at least one second tube element is provided. The second tube element comprises at least one second tube which is inflatable with the gas and is formed by at least two layers or plies arranged one on top of the other, each formed from a per se limp material and connected along at least one second seam with each other.

Further, the second tube can comprise at least one second free end. As will be set out in more detail in the following, the tube parts can be provided as components that are initially separate or separated from each other or else as components that are already connected with each other or cohesive and thus in particular as already manufactured integral unit.

As part of the method according to the invention the tube elements are provided in such a way that the seams are arranged on respective facing sides of the tube elements. The seams thus are directly adjacent seams, since preferably between the seams there is no further seam of the volume element arranged. Therein the seams have at least in respective length portions curvatures that are different from each other. In other words for instance the first seam has at least in a first length portion a first curvature, wherein the second seam at least in a second length portion has a second curvature. Therein the curvatures are different from each other, wherein preferably the length portions are directly adjacent or directly opposite each other.

The curvatures for example with regard to their sign and/or with regard to their shape or their course as such are different. In other words, it is conceivable that the curvatures differ from each other merely with regard to their sign and otherwise have the same shape or the same course. Further, it is conceivable that the curvatures have the same sign and differ from each other with regard to their course or with regard to their shape. Further, it is conceivable that the curvatures differ from each other both with regard to their sign as well as with regard to their shape or their course.

For instance the tube elements are further provided in such a way that the free ends, in particular initially, are spaced apart from each other. In this connection the method comprises for instance a third step, in which the ends, which are in particular initially spaced apart from each other, are moved towards each other. Therein the ends are for instance moved towards each other in such a way that the distance between the ends is reduced, wherein the ends can be moved in such a way towards each other that they, after having been moved towards each other, are still spaced apart from each other or else touch or overlap. In particular, in this connection it can be envisaged in this connection that the tube elements in a state, in which the ends are moved towards each other, are connected with each other. In other words, the ends are for instance moved towards each other, whereby in this state of the volume element the tube elements are connected with each other. Thereby, for instance the state, in which the ends are moved towards each other, is fixed. In particular it is conceivable that the tube elements are connected with each other via their ends, which are in particular moved towards each other, wherein for instance the ends are connected with each other, for instance mechanically. Alternatively or additionally, it is conceivable that the tube elements are connected with each other via respective partial portions, which extend from the free ends, in particular in longitudinal extension direction of the volume element.

Experiments with prototypes have shown that by the inventive method a particularly simple, time-efficient and cost-efficient manufacture of the volume element, which for instance is configured as water sports equipment, can be realized. Moreover, the formation of folds when the volume element is inflated and thus is in the state of being inflated with the gas can be avoided or at least kept to a minimum so that both a particularly advantageous optical impression of the volume element as well as particularly advantageous properties of the volume element, in particular with regard to the use of the volume element as water sports equipment, can be realized. By the use of the tube elements further a particularly advantageous structure, i.e. a particularly advantageous type or way of construction of the volume element can be realized.

The term advantageous structure relates for instance to the fact that the volume element, in particular in its inflated state, has a particularly advantageous, in particular outer shape and/or a particularly advantageous cross-section, in particular a particularly advantageous cross-sectional shape, wherein the volume element despite the realization of the advantageous and possibly complex structure by means of the inventive method can be manufactured in a simple and thus time-efficient and cost-efficient way. It is in particular possible to realize a thickness varying for instance along at least one extension direction of the volume element or thickness distribution of the volume element, whereby a particularly advantageous structure and—in particular with regard to the use of the volume element as or for a water sports equipment—particularly good properties of the volume element can be realized.

Whilst the structure of the volume element, which is realizable by means of the method according to the invention, may possibly be complex, however, the structure makes the realization of particularly advantageous properties of the volume element possible and moreover the volume element despite the use of the complex structure by means of the method according to the invention can be manufactured in a simple and time-efficient and cost-efficient manner. Further, the formation of excessive folds can be avoided. Moreover, the method allows for realizing a high stability, in particular a particularly high stiffness, of the volume element.

In an initial state, in which the tube elements are not inflated, the tube elements lie in an at least substantially horizontal plane, and for instance the ends are not yet moved towards each other, for instance at least one central line exists, relative to which the adjacent seams, in particular the tube elements, extend or can be configured symmetrically, in particular mirror-symmetrically. In the previously described initial state for instance the respective length portions of the seams initially do not lie on the central line. If the ends or the tube elements starting from the described state are moved towards each other, the seams or their length portions for instance come to lie on the central line or the seams come to lie in a plane, in which the central line extends.

For example, the seams are initially spaced from each other and then, in particular after the second step, are at least partly moved towards each other. Therein for instance the tube elements or respective sub-areas of the tube elements, which initially are spaced apart from each other, are moved towards each other, whereby for instance a state is created, in which the tube elements are connected with each other or which is fixed by connecting the tube elements, in particular their initially spaced apart sub-areas.

By moving the tube elements, the sub-areas, the ends, or the seams towards each other and before the tube elements or the volume element on the whole are or is inflated, the volume element for instance has an at least substantially three-dimensional shape, which for instance is similar to the shape of a kayak or canoe. This is for instance the case since the volume element due to the fact that the initially spaced apart seams or sub-areas are or were moved towards each other, at least on one side has a curvature that is similar to the curvature of a kayak or a canoe at its tip.

If then, however, the tube elements or the tubes are inflated with the gas, the shape of the volume element that is similar to the shape of a kayak or a canoe disappears or diminishes and the volume element on its top side and bottom side becomes at least substantially even or flat. In other words, by moving the free ends or the sub-areas and thus the tube elements towards each other and by connecting the tube elements in the described state, in which the free ends or the sub-areas are moved towards each other, the volume element initially has a curvature, which leads to it that the volume element has a shape reminiscent of a kayak or a canoe. If then, however, the tube elements or the tubes are inflated, this curvature decreases or the curvature disappears so that the volume element for instance on its top side and bottom side becomes at least essentially even or flat and forms a surface, on which a person can stand particularly well. Due to the method according to the invention, however, upon inflating the tube elements or the tubes no excessive formation of folds occurs, wherein by the use of the tubes a particularly high stability can be realized.

Therein the method according to the invention is based on the following insights: Point of departure for the development and construction of a volume element, which is for instance configured as surfboard, air mattress, or standup paddle board, are the afore-described layers, which are per se pliable or limp as to their shape, however, preferably airtight and each of which, in particular when they lie one on top of the other and in an at least substantially horizontal plane for instance a table top, have an at least substantially planar and two-dimensional shape. For forming the tubes these layers are placed one on top of the other and along the respective seams are connected with each other. Also in such a state of the layers, in which they are connected with each other and arranged one on top of the other, however, not yet inflated, the tube elements and thus the volume element on the whole has an at least substantially two-dimensional extension or shape, since the volume element has a particularly large width and length, however a particularly low thickness. By the inflating of the tube elements or the tubes the initially at least substantially two-dimensional tube elements, however, are transferred into an at least substantially three-dimensional shape since by the inflating the thickness of the tube element is clearly increased.

In the non-inflated state the layers at least in the area of the respective tubes lie on top of each other. When inflating the tube elements and thus the tubes the gas, which for instance is configured as air, is passed into the respective tubes so that the layers in the area of the tubes are lifted from each other. It was found that the tubes or the tube elements upon inflation, i. e. upon transfer from the at least substantially two-dimensional state into the at least substantially three-dimensional state, change heavily in their shape so that upon inflating such volume elements, which comprise tubes and are for instance configured as inflatable surfboard or standup paddle board, the formation of folds occurs. The reason for the formation of these folds is that the construction or the design of the seams commonly is effected in the two-dimensional state and therein does not consider the three-dimensional state, i. e. the inflated state or the transition from the two-dimensional state into the three-dimensional state.

However, this is the case with the method according to the invention and thus with volume elements manufactured by means of the method according to the invention. In other words as part of the method according to the invention already when designing or constructing the seams in the—viewed in an idealized manner—two-dimensional state the later, three-dimensional state or the transition from the two-dimensional state into the three-dimensional state is taken into consideration. In other words, the seams as part of the method according to the invention in the two-dimensional state are already adjusted to the three-dimensional, i. e. inflated state of the volume element so that the seams in the non-inflated and thus two-dimensional state of the volume element are manufactured in such a way that the course or the curvature of the seams does not lead to folds in the inflated and thus three-dimensional state of the volume element and that the volume element upon inflation, i. e. upon transfer from the two-dimensional state into the three-dimensional state, loses the shape, which is reminiscent of a kayak or a canoe, and thus on the top side or bottom side is at least substantially even or flat, in particular with regard to a plane tangent to the tubes.

Further, the method according to the invention facilitates the realization of a particularly high stiffness and thus stability of the volume element in its inflated state so that the volume element in its inflated state can be used particularly well as water sports equipment. In its uninflated or non-inflated state the volume element—since the tube elements or the layers are formed from the per se flexible material—can be folded together and/or rolled up particularly well so that the construction space requirement of the volume element in its non-inflated state can be kept particularly low. In other words, the volume element in its non-inflated and rolled-up or folded state has a merely small packing dimension so that the volume element can be stowed and transported in a particularly simple and space-saving way.

For realizing particularly advantageous properties of the volume element it is preferably envisaged that the per se limp material is at least substantially inelastic. This means that whilst the limp material is per se limp, as a consequence of the inflating, however, it does not expand, i.e. does not increase in its length or extension. Thereby a very high robustness and stability can be provided. The limp material, which preferably is airtight, is for instance a fiber-reinforced plastic, in particular a fiber-reinforced elastomer such as for instance hypalon. Further, it is conceivable that the material is configured as PVC (polyvinyl chloride) or PU (polyurethane) coated polyester fabric.

For instance the volume element can be used already as such as water sports equipment. However, it has proven advantageous if the volume element is used as core for a volume device, in particular a water sports equipment or a water sports device. Therein the volume element is equipped for instance with an envelope which envelops the volume element at least partially, in particular predominantly. Therein the envelope is for instance formed from a per se limp and preferably airtight and/or inelastic material. The tubes therein form for instance respective first chambers, which can be inflated, by passing, in particular blowing, the afore-mentioned gas into the first chambers (tubes). Preferably the volume element has at least one first connection, via which the gas can be passed or introduced into the tubes (first chambers).

On at least one side, which faces away from the first chambers, the volume element (core) bounds for instance at least one second chamber at least partly, which is bounded partly by the volume element and partly by the envelope. The second chamber thus is arranged between the volume element and the envelope which is also referred to as a cover. For realizing a particularly high stiffness preferably in the second chamber granular matter is arranged. Further the second chamber can be evacuated. For this purpose the volume device comprises at least one second connection, via which the second chamber can be evacuated. This means that a gas such as air initially contained in the second chamber can be discharged from the second chamber at least partly, in particular at least predominantly. Thereby the envelope is sucked against the volume element, whereby the granular matter arranged in the second chamber is compressed between the volume element and the envelope. This leads to a very high stiffness of the volume device or a water sports equipment formed by the volume device.

The volume element manufactured by the method according to the invention has a particularly advantageous applicability since on the one hand in the non-inflated state it can be put together, in particular folded together and/or rolled together and thus has a low construction space requirement, i. e. a small packing dimension. Further the volume element with regard to its weight is very light and as a consequence is very easy to be transported. On the other hand the volume element in its inflated state has a very high stiffness, in particular against pressure force loads, which is particularly advantageous for the use as water sports equipment. The following and the previous features, advantages, and embodiments by all means also apply to the volume device comprising the volume element as core.

In an advantageous embodiment of the invention the tube elements are provided in such a way that the seams are spaced apart from each other along their respective complete extension. It was found that hereby a particularly simple and thus time and cost-efficient manufacture can be realized. Further the seams with regard to their curvature can be particularly advantageously designed so that the volume element in its inflatable state has a particularly advantageous shape and stability without the occurrence of excessive formation of folds.

As already suggested, it is possible that the tube elements are provided as cohesive or interconnected components and thus for instance as integral unit. For this purpose for instance at least one first layer of limp material, which is common to the tube elements, as well as one second layer of limp material, which is common to the tube elements, is provided, wherein the layers are arranged on top of each other and are connected with each other along the seams. This means that both the first tube as well as the second tube are partly formed from the for instance single-piece first layer as well as partly from the for instance single-piece second layer, which is arranged on top or under the first layer.

For realizing a particularly time-efficient and cost-efficient manufacture, however, it has turned out to be advantageous if the tube elements are provided as separately formed tube parts. Therein the tube parts can for instance be assembled and, in particular in the afore-mentioned way, be connected with each other. If the tube elements are provided as tube parts, it is for instance envisaged that the first tube is formed from a first layer of limp material and from a second layer of limp material, wherein the first layer is arranged on the second layer and is connected with the second layer at least along the first seam. Further, the second tube is formed for instance from a third layer of limp material and from a fourth layer of limp material, wherein the third layer is arranged on the fourth layer and, at least along the second seam connected with the fourth layer and wherein the first layer is formed separately from the second, third, and fourth layer, the second layer separately from the first, third, and fourth layer, the third layer separately from the first, second, and fourth layer, and the fourth layer separately from the first, second, and third layer.

A further embodiment is characterized in that the ends are moved in such a way towards each other that the ends touch. Hereby the tube elements, in particular via the touching ends, can be connected particularly advantageously with each other, wherein the module element can be manufactured with a particularly low material requirement and thus cost-efficiently.

In a further embodiment of the invention it is envisaged that the ends are moved towards each other by a sub-area of the respective tube element comprising the respective ends being folded about a folding axis. Thereby the ends can be moved towards each other in a particularly simple way and for instance—as described before—come to lie on the central axis or on the plane. Moreover, the volume element on the whole thereby can be handled particularly easily.

It has proven particularly advantageous if the respective layer comprises fibers or is manufactured from fibers. In particular the layer therein is formed as a fabric. Therein the tube elements and thus the layers are preferably provided in such a way that the fibers of the layers enclose with the longitudinal extension direction of the volume element on the whole an angle, which lies in a range of 25° inclusively to 65° inclusively, in particular of 35° inclusively to 55° inclusively. In other words, the respective flexible material is oriented and arranged in such a way that the fibers of the limp material are arranged at an angle of 45°+−20° relative to the longitudinal extension direction. By such an orientation of the fibers a particularly advantageous torsional stiffness can be realized. Moreover, the formation of folds can be prevented particularly well since the material can expand in corresponding directions.

In other words by this fiber orientation an advantageous shapeability can be realized. This is advantageous for the so-called rocker of the volume element, which is for instance configured as surfboard or employed for a surfboard. The term rocker refers to an upward bending, a curvature, or a bend of the volume element, for instance on its top side, wherein the rocker by the described fiber alignment can be manufactured in a particularly advantageous way. Initially, the volume element, in particular as part of its manufacture, is flat. By the described fiber orientation or arrangement the volume element can be brought or forced particularly easily into the bend, i. e. into the rocker. This means that by the fiber orientation a particularly advantageous shapeability of the volume element can be realized.

A further embodiment is characterized in that the tubes and thus the tube elements for instance via the afore-mentioned, initially spaced apart sub-areas, in particular via the initially free ends, are fluidically and/or mechanically connected with each other. The mechanical connecting means that the tube elements or the ends are fixed to each other. The fluidic connecting refers to the fact that gas can flow from one of the tubes into the other tube or vice versa. By the mechanical and/or fluidic connecting of the tube elements, in particular via the ends, wherein for instance the ends are connected with each other mechanically and/or fluidically, a particularly advantageous stability of the volume element, in particular in its inflated state can be realized.

Alternatively or additionally it is possible that the tube elements are connected with each other via respective sub-areas extending from the ends, wherein the ends are not necessarily connected with each other. Hereby it is equally possible to realize the shape that is advantageous in the non-inflated state and reminiscent of a canoe or kayak, which then upon inflating the volume element reverts, however by connecting the ends a particularly advantageous stability can be realized.

It has proven particularly advantageous if the sub-areas or the tube elements are connected with each other, in particular via the ends, by means of at least one adhesive bond. By means of such adhesive bond a weight-efficient and cost-efficient, though at the same time particularly strong joint can be realized.

In a further embodiment of the invention the respective layers along the respective seam are connected with each other by gluing and/or welding and/or sewing. In other words, the term seam does not necessarily mean that the layers are sewed together by means of a thread. As part of the invention the term seam generally refers to an at least substantially line-shaped connection spot or an at least substantially line-shaped connection area, at which or in which the layers are connected with each other. If the layers for instance are connected with each other along the seam by gluing, the respective seam is configured as adhesive bond seam. If the layers for instance are connected with each other along the seam by welding, the seam is configured for instance as welding seam. If the layers for instance along the respective seam are connected with each other by means of at least one thread or by means of at least one yarn, the respective seam is configured for instance as sewing seam.

Finally it has turned out to be advantageous if the volume element is manufactured as water sports equipment, in particular as surfboard, paddle board, standup paddle board, or air mattress or is used for such a water sports equipment, in particular as core. The term standup paddle board refers to an afore-mentioned standup paddleboard, on which at least one person can stand. With the aid of a paddle the person standing on the volume element can move along on the water.

Further advantages, features, and details of the invention derive from the following description of preferred embodiments as well as by reference to the drawing. The afore-mentioned features and feature combinations as well as the features and feature combinations previously named in the description as well as named in the following in the description of the figures and/or shown in the figures alone are usable not only in the respective indicated combination but also in other combinations or taken alone without departing from the scope of the invention.

The drawing shows in:

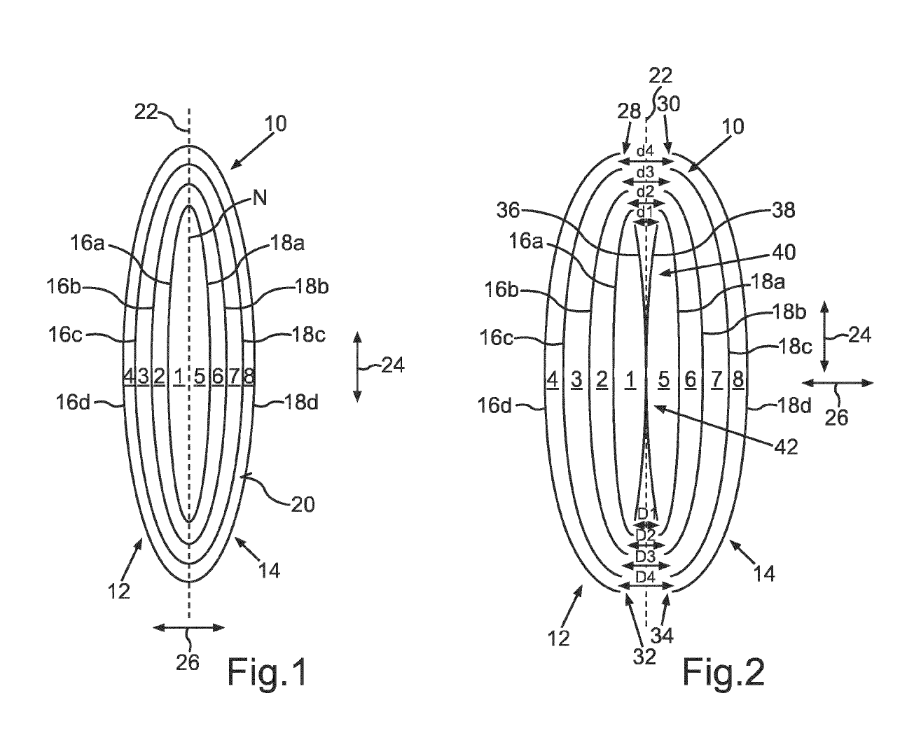

FIG. 1 a schematic plan view of a volume element configured as a water sports equipment in its inflated state;

FIG. 2 a schematic plan view of tube elements of the volume element, wherein FIG. 2 serves for illustrating a first embodiment of a method for manufacturing the volume element;

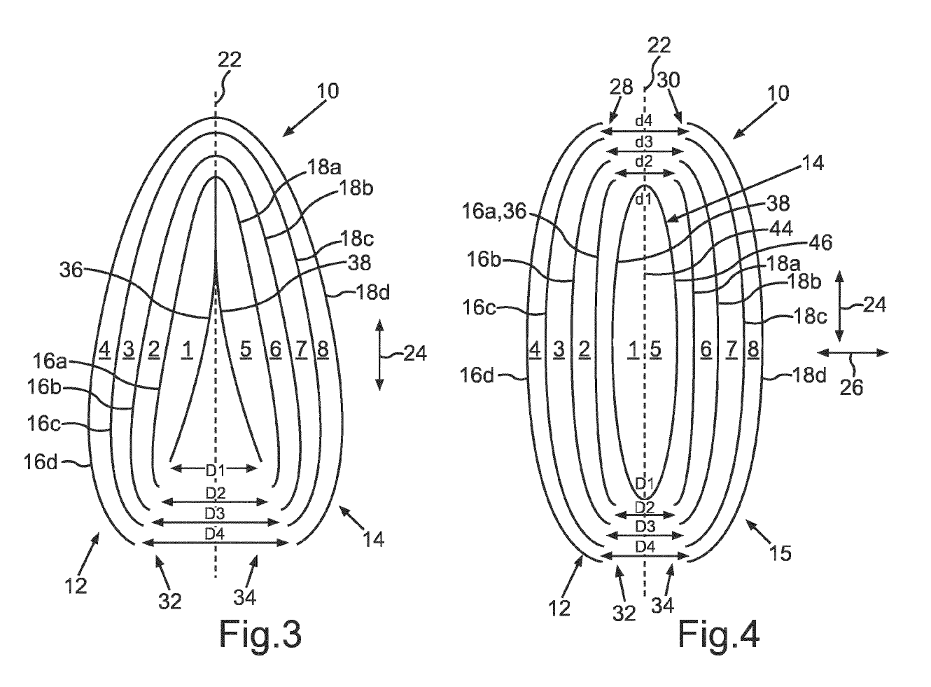

FIG. 3 a schematic plan view of the tube elements, wherein FIG. 3 serves for illustrating a second embodiment for manufacturing the volume element;

FIG. 4 a schematic plan view of the tube elements, wherein FIG. 4 serves for illustrating a third embodiment of the method for manufacturing the volume element;

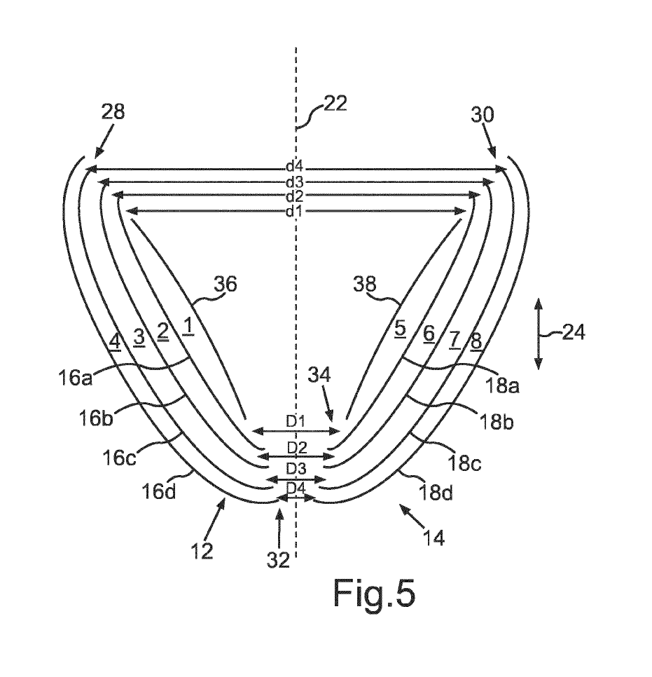

FIG. 5 a schematic plan view of the tube elements, wherein FIG. 5 serves for the illustrating a fourth embodiment of the method for manufacturing the volume element;

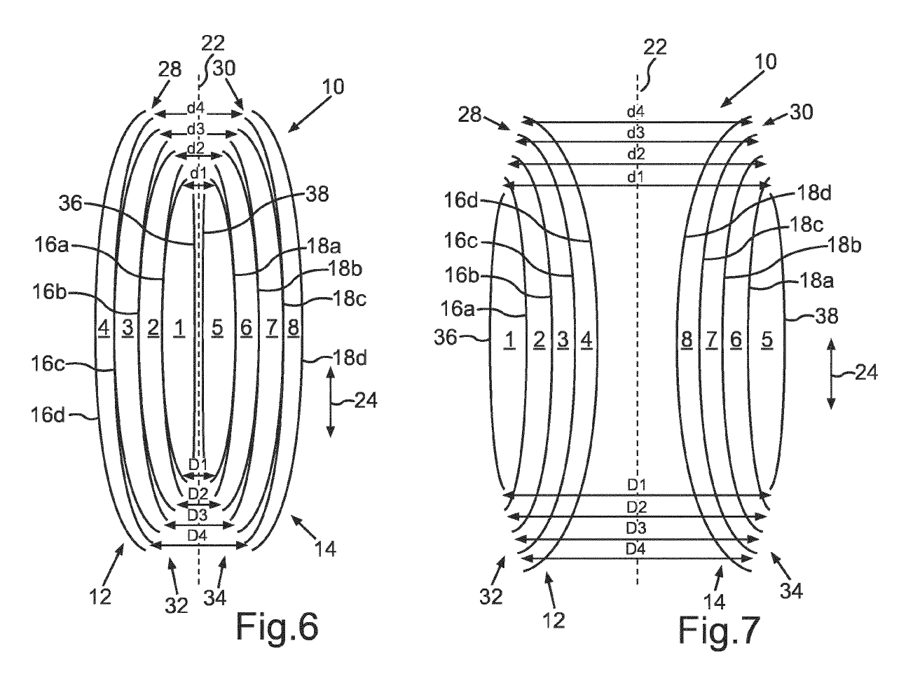

FIG. 6 a schematic plan view of the tube elements, wherein FIG. 6 serves for illustrating a fifth embodiment of the method for manufacturing the volume element;

FIG. 7 a schematic plan view of the tube elements, wherein FIG. 7 serves for illustrating a sixth embodiment of the method for manufacturing the volume element;

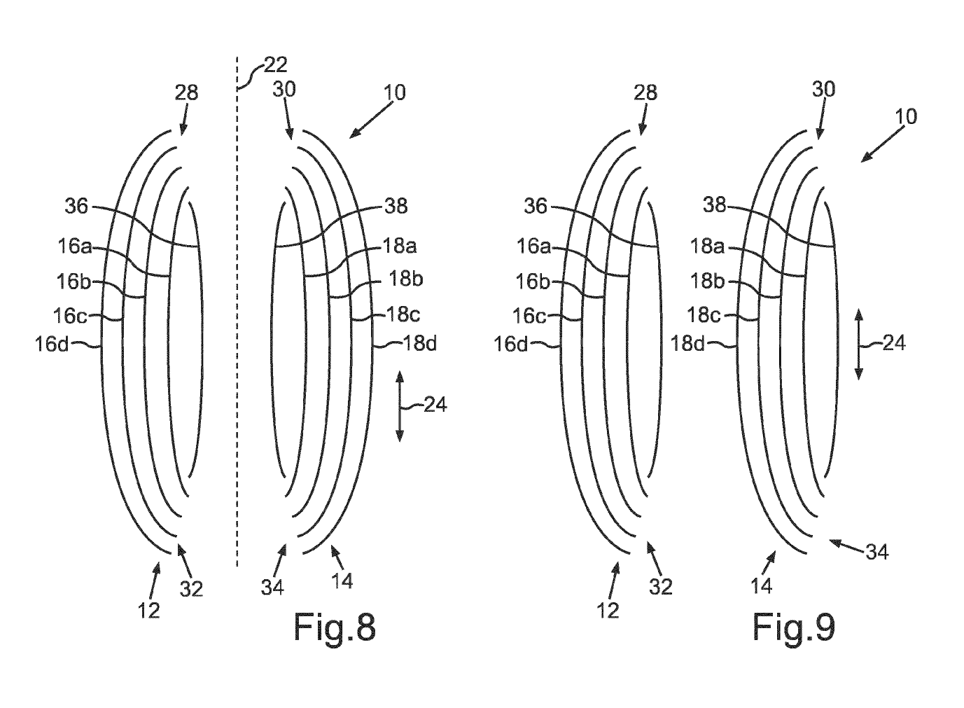

FIG. 8 a schematic plan view of the tube elements, wherein FIG. 8 serves for illustrating a seventh embodiment of the method for manufacturing the volume element; and

FIG. 9 a schematic plan view of the tube elements, wherein FIG. 9 serves for illustrating an eighth embodiment of the method for manufacturing the volume element.

In the figures identical or functionally identical elements are equipped with the same reference signs.

FIG. 1 in a schematic plan view shows a volume element designated as a whole as 10, wherein in FIG. 10 an inflated state of the volume element 10 is illustrated. The volume element 10 is configured therein as water sports equipment, wherein the volume element 10 can be configured as surfboard, paddle board, or standup paddle board. Further, it is conceivable that the volume element 10 is used for such water sports equipment representing a volume device. Therein the volume element 10 for instance is a core, which at least partly, in particular predominantly, is enveloped by an envelope.

The volume element 10 comprises a multitude of tubes 1, 2, 3, 4, 5, 6, 7, and 8, which are inflatable with a gas, in particular with air. This means that for inflating the volume element 10 the named gas is passed, in particular blown, into the tubes 1, 2, 3, 4, 5, 6, 7, and 8. By inflating the tubes 1, 2, 3, 4, 5, 6, 7, and 8 the volume element 10 is transferred from its uninflated state or non-inflated state into its inflated state.

The tubes 1, 2, 3, and 4 are components of a first tube element 12, wherein the tubes 5, 6, 7, 8 are components of a second tube element 14 of the volume element 10. This means that the first tube element 12 of the volume element 10 comprises the tubes 1, 2, 3, and 4, wherein the tube element 14 of the volume element 10 comprises the tubes 5, 6, 7, and 8. As part of the method for manufacturing the volume element 10 for instance in a first step of the method the first tube element 12 is provided, which comprises the tubes 1, 2, 3, and 4, which are inflatable with the gas. Therein the tube 1 is for instance a so-called first tube of the volume element 10 or the tube element 12. In a second step of the method for instance the second tube element 14 is provided, which comprises the tubes 5, 6, 7, and 8, which are inflatable with the gas. Therein the tube 5 is for instance a second tube of the tube element 14.

If the tube elements 12 and 14 are provided for instance as separate or separately configured tube parts, the tube element 14 for instance comprises at least one first layer and at least one second layer that is configured separately from the first layer, wherein the respective layer is formed from a per se limp material, i.e. a material that is limp as to its shape. Whilst the material is preferably limp, however, it is airtight and inelastic, i.e. non-elastic. Thus the material upon inflation does not or only slightly expand. Further upon provision of the tube elements 12 and 14 as separate tube parts the tube element 14 for instance comprises a third layer that is configured to be separate from the first layer and separate from the second layer as well as a fourth layer that is configured to be separate from the first, second, and third layer. Also the third and fourth layer are each formed from a per se limp material, wherein the previous and the following explanations given with regard to the first layer can also be applied to the other layers and vice versa. The respective layer or the respective material for instance comprises fibers or is at least formed from fibers, wherein the respective layer or the respective material can be configured as a fabric.

For manufacturing the tube element 12 the first layer is arranged on the second layer and for manufacturing the tubes 1, 2, 3, and 4 connected along respective seams 16a-d with the second layer. The respective seam 16a-d is an at least substantially line-shaped connection spot or an at least substantially line-shaped connection area, at which or in which the first layer is connected with the second layer, whereby the tubes 1, 2, 3, and 4 are formed. Therein from FIG. 1 it can be seen that the respective seam 16a-d at least in a respective length portion has a curved course and thus a curvature.

For manufacturing the tube element 14 for instance the third layer is arranged on the fourth layer and along respective seams 18a-d connected with the fourth layer. Therein the following and previous explanations given with regard to the respective seam 16a-d can be applied to the respective seam 18a-d and vice versa. The respective layers are glued to each other for instance along the respective seam 16a-d or 18a-d and/or welded together and/or sewed together and/or connected in a different way with each other.

The tube elements 12 and 14 are for instance at least mechanically connected with each other so that the tube elements 12 and 14 are fixed to each other. For instance the first tube element 12 is manufactured by connecting the first layer with the second layer whilst forming the tubes 1, 2, 3, and 4. Further, for instance initially the second tube element 14 is manufactured by connecting the third layer with the fourth layer and whilst forming the tubes 5, 6, 7, and 8. The tube elements 12 and 14, which comprise the respective tubes 1, 2, 3, and 4 or 5, 6, 7, and 8, thus are initially separate components, which for instance are connected at least mechanically with each other. For this purpose for instance the first tube 1 is at least mechanically connected with the second tube 5. For this purpose for instance at least respective, initially spaced apart sub-areas of the tube elements 12 and 14 are moved towards each other and then, in particular mechanically, connected with each other.

Alternatively or additionally it is conceivable that the tubes 1, 2, 3, 4, 5, 6, 7, and 8 via their respective, initially free ends are connected with each other at least mechanically. Alternatively or additionally it is conceivable that the tubes 1 and 5 via their respective, initially free ends are connected with each other at least mechanically and/or that the tubes 1 and 5 via respective sub-areas extending from the respective free end of the tubes 1 and 5 are connected with each other at least mechanically. In particular it can be envisaged that the respective tubes 1, 2, 3, 4, 5, 6, 7, and 8, in particular via their respective initially free ends, are connected fluidically with each other so that for instance the afore-mentioned gas can flow between the tubes 1, 2, 3, 4, 5, 6, 7, and 8 (1-8).

FIG. 1 shows the volume element 10 in its inflated state, in which the volume element 10 on its top side 20, which can be discerned in FIG. 1, and on its bottom side, which faces away from the top side 20 and cannot be discerned in FIG. 1, at least substantially is configured even or flat. Further, the volume element 10 in its inflated state has no folds or only a very small number of minor folds. This is realizable by a special method for manufacturing the volume element 10, wherein this method or several embodiments of the method is or are explained in the following.

As an alternative to the provision of tube elements 12 and 14 as separate tube parts it is possible to provide the tube elements 12 and 14 as interconnected tube elements or as coherent integral unit. Therein the first layer is configured as a single piece with the third layer so that the first layer and the third layer for instance form a fifth layer. Further, the second layer is configured as a single piece with the fourth layer so that the second and the fourth layer form a single-piece sixth layer that is configured to be separate from the fifth layer. For manufacturing the tube elements 12 and 14 for instance the fifth layer is arranged on the sixth layer and along the seams 16a-d and 18a-d is connected with the sixth layer, whereby the tubes 1-8 are manufactured.

FIG. 1 shows the volume element 10 for instance in an idealized or simplified representation, in which the tubes 1 and 5, in particular the tube elements 12 and 14, relative to an imaginary central axis 22 are configured to be symmetrical, in particular mirror-symmetrical relative to each other. The central axis 22 thus is a symmetry axis, which lies in a symmetry plane extending perpendicularly to the image plane of FIG. 1. Further, the volume element 10 has a longitudinal extension direction shown in FIG. 1 by a double arrow 24 since the volume element 10 has a length extending along the longitudinal extension direction, the length being larger than a width extending along a second direction extending perpendicularly to the longitudinal extension direction. This second direction is illustrated in FIG. 1 by a double arrow 26.

Based on FIG. 2 in the following a first embodiment of the method for manufacturing the volume element 10 is illustrated. From FIG. 2 it can be seen that the tube elements 12 and 14 are provided in such a way that the respective tubes 1, 2, 3, and 4 (1-4) each comprise a first free end 28 and the tubes 5, 6, 7, and 8 (5-8) each comprise a second free end 30, wherein the free ends 28 and 30 initially are spaced apart from each other. In the first embodiment between the free ends 28 and 30 of the tubes 1 and 5 a first distance d1, between the free ends 28 and 30 of the tubes 2 and 6 a second distance d2, between the free ends 28 and 30 of the tubes 3 and 7 a third distance d3, and between the free ends 28 and 30 of the tubes 4 and 8 a fourth distance d4 is provided. Therein the distance d1 is smaller than the distance d2, which is smaller than the distance d3, which in turn is smaller than the distance d4. In other words, it applies: d1<d2<d3<d4.

Further in the first embodiment the tube elements 12 and 14 are provided in such a way that the tubes 1 to 4 each have a third free end 32 and the tubes 5-8 each have a fourth free end 34, wherein the free ends 32 and 34 initially are spaced apart from each other. Thus between the free ends 32 and 34 of the tubes 1 and 5 a distance D1, between the free ends 32 and 34 of the tubes 2 and 6 a distance D2, between the free ends 32 and 34 of the tubes 3 and 7 a distance D3, and between the free ends 32 and 34 of the tubes 4 to 8 a fourth distance D4 exists. It applies: D1<D2<D3<D4. This means that the respective distance between the respective free ends 28 and 30 or 32 and 34 in the longitudinal extension direction of the volume element 10 increases towards the outside. The tube elements 12 and 14 thus are provided in such a way that at least respective sub-areas of the tube elements 12 and 14 comprising the respective ends 28 and 30 or 32 and 34 are initially spaced apart from each other.

This provision of the tube elements 12 and 14 for instance in the provision of the tube elements 12 and 14 as integral unit is realized in such a way that between the tube elements 12 and 14 material is detached or cut out, in particular at least substantially in the shape of a triangle or wedge. In other words the described provision of the tube elements 12 and 14 is realized for instance by corresponding processing, in particular trimming, of the tube elements 12 and 14, in particular the respective layers.

From FIG. 2 it can further be seen that the respective layers are also connected with each other along respective seams 36 and 38, wherein the first tube 1 is formed at least partly by the seam 36, in particular by the seams 36 and 16a, and the tube 5 at least partly by the seam 38, in particular by the seams 38 and 18a. In the first embodiment the seam 36 is a first seam, wherein the seam 38 is a second seam.

The seams 36 and 38 in FIG. 1 cannot be discerned or not as precisely one seam N since the seams 36 and 38 in the finished manufactured and inflated state of the volume element 10 coincide and therein lie in particular on the central axis 22. In a state illustrated in FIG. 2, in which the volume element 10 is not yet completely manufactured and not inflated, i. e. uninflated, the seams 36 and 38 do not fully coincide or do not fully lie on the central axis 22. In other words: As part of the method the tube elements 12 and 14—as can be seen from FIG. 2—are provided in such a way that the free ends 28 and 30 or the ends 32 and 34 are arranged spaced apart from each other and the seams 36 and 38 are arranged on sides of the tube elements 12 and 14 which face each other. The seams 36 and 38 thus are adjacent seams, in particular immediately adjacent or directly adjacent seams, since between the seams 36 and 38 no further seams of the volume element 10 are arranged. Therein the seams 36 and 38 at least in respective length portions 40, which in the present case are directly adjacent and directly opposite each other, have curvatures that are different from each other. From FIG. 2 it can be seen that the seams 36 and 38 in the respective length portion 40 have the same shape or the same course, however, the curvatures of the seams 36 and 38 in the respective length portion 40 differ from each other with regard to their sign, since the seam 36 relative to the image plane of FIG. 2 curves towards the left away from the central axis 22 and the seam 38 curves towards the right away from the central axis 22. This state, which is illustrated in FIG. 2, the volume element 10 has adopted for instance if the volume element 10 lies on a tabletop or on an at least substantially horizontal plane and is uninflated.

The sub-areas, which are initially free and spaced apart from each other, in the present case the ends 28 and 30 or 32 and 34 are then moved towards each other, whereby for instance the volume element 10 adopts a connected state or reaches a connected state, in which the tube elements 12 and 14, in particular via their free ends 28 and 30 or 32 and 34 and/or via sub-areas extending in the longitudinal extension direction from the free ends 28 and 30 or 32 and 34, are at least mechanically connected with each other. By this connecting of the tube elements 12 and 14 the afore-mentioned connected state, in which the sub-areas, in particular ends 28 and 30 or 32 and 34 are moved towards each other, is fixed. In the fixed connected state the initially non-inflated volume element 10 for instance has a shape, which is similar to a shape of a kayak or canoe or which is reminiscent of the shape of a kayak or canoe. This is for instance the case since the volume element 10 in its non-inflated state on the top side 20 and/or on the bottom side has a curvature similar to the curvature of a kayak or a canoe at its tip. If then, however, the volume element 10 is inflated so that the afore-mentioned curvature of the volume element 10 is at least diminished or removed. This means that by the inflating of the volume element 10 or the tubes 1-8 the shape that is reminiscent of a kayak or canoe reverts so that the volume element 10 in its inflatable state on the top side 20 and on the bottom side is at least substantially even or flat. Further, the seams 36 and 38 come to lie on the central axis 22 or coincide.

In the first embodiment the tube elements 12 and 14 are provided in such a way that for instance the seams 36 and 38 in their length portions 40 do not touch and in the length portions 40 are spaced apart from each other, wherein the seams 36 and 38 touch in respective second length portions 42 extending in the longitudinal extension direction of the volume element 10 from the respective length portions 40.

If the volume element 10 is used for instance as core of a volume device and—as suggested above—at least partly, in particular at least largely, is enveloped and thus sheathed by an envelope, which is also referred to as sheath, therein for instance a so-called rocker of the volume element 10 or the volume device on the whole is created. The envelope forms for instance an outer skin of the volume device. The term rocker refers to a curvature, bend, or upward bending, which comprises the volume element 10 or the volume device—in particular after the manufacture of the rocker—at least in the inflated state.

As part of the manufacture of the volume device the volume element 10 for instance is initially flat, in particular in the inflated state. For instance by means of a mould the rocker is manufactured. For instance the envelope is glued together with the core (volume element 10), wherein the envelope for instance is glued upon the core. It has turned out to be particularly advantageous if the tube elements 12 and 14 and thus the layers are provided in such a way that the fibers of the layers enclose with the longitudinal extension direction of the volume element 10 an angle which lies in the range of 25° inclusively to 65° inclusively, in particular from 35° inclusively to 55° inclusively. In other words the respective limp material is aligned and arranged in such a way that the fibers of the limp material are arranged at an angle of 45°+−20° relative to the longitudinal extension direction. By such an orientation of the fibers a particularly advantageous torsion stiffness can be realized. Moreover the formation of folds can be prevented particularly well since the material can expand in corresponding directions. Moreover, by this fiber alignment a particularly advantageous shapeability can be realized so that the rocker can be manufactured particularly well.

In order to realize therein a particularly high stiffness, in particular bending stiffness, of the volume device, it is preferably envisaged that the envelope for instance is formed from a per se limp and preferably airtight and/or inelastic material. The tubes 1-8 therein form for instance respective first chambers, which can be inflated by passing, in particular blowing, the afore-mentioned gas into the first chambers (tubes 1-8). Preferably, the volume element 10 has at least one first connection, via which the gas can be passed or introduced into the tubes 1-8 (first chambers).

On at least one side facing away from the first chambers the volume element 10 (core) for instance bounds at least one second chamber at least partly, which is partly bounded by the volume element 10 and partly by the envelope. The second chamber thus is arranged between the volume element 10 and the envelope, which is also referred to as sheath. For realizing a particularly high stiffness preferably in the second chamber granular matter is arranged. Further, the second chamber can be evacuated. For this purpose the volume device comprises at least one second connection, via which the second chamber can be evacuated. This means that a gas that is initially contained in the second chamber such as for instance air can be discharged from the second chamber at least partly, in particular at least predominantly, whereby the granular matter arranged in the second chamber is compressed between the volume element 10 and the envelope. This leads to a very high stiffness of the volume device or of a water sports equipment formed by the volume device.

FIG. 3 shows a second embodiment of the method, in which the tube elements 12 and 14 are provided for instance as integral unit, wherein the respective tubes 1-8 each comprise only exactly one free end 32 or 34. In the first and the second embodiment precisely two tube elements 12 and 14 are provided, wherein the number of tubes 1-8 is larger than the number of tube elements 12 and 14.

FIG. 4 shows a third embodiment of the method, in which three tube elements 12, 14, and 15 are provided. In the third embodiment the tube element 14 or its tubes 1 and 5 has no free ends, however the tube element 14 has the tubes 6, 7, and 8 with the free ends 30 or 34. In the third embodiment a first one of the directly adjacent seams having the different curvatures is the seam 16a of the tube element 12. The second one of the directly adjacent seams is the seam 38 of the tube element 14, which is arranged between the tube elements 12 and 15. The tubes 1 and 5 of the tube element 14 are formed by the seams 44 and 46 as well as by the seam 38, wherein further the seams 18a and 46 are immediately adjacent seams, which at least in the respective length portions, have different curvatures. In the third embodiment the initially free ends 28 and 30 or 32 and 34 of the tube elements 12, 14, and 15 are moved towards each other.

FIG. 5 shows a fourth embodiment of the method, wherein the fourth embodiment with regard to the arrangement and in particular alignment of the tube elements 12 and 14 relative to each other differs from the afore-described embodiments. FIG. 6 shows a fifth embodiment of the method, wherein the tube elements 12 and 14 are provided in such a way that the immediately adjacent seams 36 and 38 over their respective entire extension are spaced apart from each other. FIG. 7 shows a sixth embodiment, in which the immediately adjacent seams are the seams 16d and 18d. Therein, however, —as described with regard to the first embodiment—the tube elements 12 and 14 are connected with each other via their sides, on which the seams 36 and 38 are arranged. Further, FIG. 8 shows a seventh embodiment of the method, in which the immediately adjacent seams 36 and 38 are provided spaced apart from each other over their complete extension. Finally, FIG. 9 shows an eighth embodiment of the method, in which the immediately adjacent seams are the seams 36 and 18d, wherein—as already described with regard to the first and the sixth embodiment—the tube elements 12 and 14 are connected with each other via the seams 36 and 38 or via the sides, on which the seams 36 and 38 are arranged.

1. A method for manufacturing a volume element which is inflatable with a gas, the method comprising the steps of:
providing at least one first tube element which comprises at least one first tube which is inflatable with the gas and is formed by at least two layers which are arranged one above the other, are formed from a per se limp material, and are connected with each other along at least one first seam; and
providing at least one second tube element which comprises at least one second tube which is inflatable with the gas and is formed by at least two layers which are arranged one above the other, are formed from a per se limp material, and are connected with each other along at least one second seam, wherein the tube elements are provided in such a way that the seams are arranged on mutually facing sides of the tube elements and have, at least in respective length portions, curvatures that are different from each other.

2. A method according to claim 1,
wherein the tube elements are provided in such a way that the seams are spaced from each other over their respective complete extension.

3. A method according to claim 1,
wherein the tube elements are provided as separately formed tube parts.

4. A method according to claim 1,
wherein the tubes comprise respective free ends, wherein the tube elements are provided in such a way that the free ends are spaced from each other, and wherein the ends are moved towards each other, in particular in such a way that the ends touch.

5. A method according to claim 4,
wherein the ends are moved towards each other by folding a sub-area of the respective tube element about a folding axis, the sub-area comprising the respective ends.

6. A method according to claim 4,
wherein the tubes are fluidically and/or mechanically connected with each other via the ends.

7. A method according to claim 4,
wherein the tubes are connected with each other via the ends by means of at least one adhesive joint.

8. A method according to claim 1,
wherein the layers are formed from fibers, and wherein the tube elements are provided in such a way that the fibers enclose with the longitudinal extension direction of the volume element an angle ranging from 25 degrees to 65 degrees, in particular from 35 degrees to 55 degrees.

9. A method according to claim 1,
wherein the respective layers are connected with each other along the respective seam by gluing and/or welding and/or sewing.

10. A method according to claim 1,
wherein the volume element is manufactured as a water sports equipment, in particular as a surf board, a paddle board, a standup paddle board or an air mattress, or is used for a water sports equipment, in particular as a surf board, a paddle board, a standup paddle board or an air mattress.
